(19) United States
(12) Patent Application Publication
(10) Pub. No.: US 2009/0063946 A1
(43) Pub. Date: Mar. 5, 2009

(54) ANCHOR STORE FOR TRANSMITTING MULTIPLE DYNAMIC ANCHORS

(75) Inventor: SWAMINATHAN BALASUBRAMANIAN, STERLING HEIGHTS, MI (US)

Correspondence Address: Law Office of Jim Boice, 3839 Bee Cave Road, Suite 201, West Lake Hills, TX, 78746, US

(73) Assignee: INTERNATIONAL BUSINESS MACHINES CORPORATION, Armonk, NY (US)

(21) Appl. No.: 12/129,465

(22) Filed: May 29, 2008

Related U.S. Application Data
(63) Continuation-in-part of application No. 11/846,589, filed on Aug. 29, 2007.

(51) Int. Cl. G06F 3/14

(52) U.S. Cl. 715/205

(57) ABSTRACT

One or more sections of a document are visually altered, by a sending computer, to create an altered document. An anchor is dynamically created for each section of the document that was altered. Each anchor is appended to a Uniform Resource Identifier (URI) for the original document. An anchor store, which includes multiple anchors for different selected regions of the altered document, is created and sent from the sending computer to a receiving computer. When the anchor store is received by the receiving computer, a receiving user can select one or more of the anchors to view the visually modified resource.

The present application is a continuation-in-part of U.S. patent application Ser. No. 11,846,589 (Attorney Docket N. END920070163US1) filed on Aug. 29, 2007, and entitled “Use of Dynamic Anchors to Transmit Content” which is incorporated herein by reference in its entirety.

### BACKGROUND OF THE INVENTION

1. Technical Field

The present disclosure relates to the field of computers, and specifically the software that runs on computers. Still more particularly, the present disclosure relates to the field of transmitting content via a network.

2. Description of the Related Art

The Internet and corporate intranets are networks that host large information spaces of resources. The most popular format to create and store resources is Hypertext Markup Language (HTML). Many other formats are also used, such as Really Simple Syndication (RSS), Microsoft WORD™ (WORD is a registered trademark of Microsoft Corporation in the United States and other countries) and LOTUS NOTES™ (NOTES and LOTUS NOTES is a registered trademark of International Business Machines, Inc. in the United States and other countries). A resource is viewed using a special program called a rendered. The renderer for a HTML resource is a web browser, while the renderer for a NOTES™ document resource is a LOTUS NOTES™ client.

### SUMMARY OF THE INVENTION

One or more sections of a document are visually altered, by a sending computer, to create an altered document. An anchor is dynamically created for each section of the document that was altered. Each anchor is appended to a Uniform Resource Identifier (URI) for the original document. An anchor store, which includes multiple anchors for different selected regions of the altered document, is created and sent from the sending computer to a receiving computer. When the anchor store is received by the receiving computer, a receiving user can select one or more of the anchors to view the visually modified resource.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use further purposes and advantages thereof, will best be understood by reference to the following detailed description of an illustrative embodiment when read in conjunction with the accompanying drawings, where:

FIG. 1 illustrates a webpage having a highlighted section that is marked by a dynamic anchor, which is created by a sender;

FIG. 2A depicts a Lotus Notes™ screen having a highlighted section, that is marked by a dynamic anchor, which is created by a sender;

FIG. 2B illustrates an integrated Development Environment (IDE) having a highlighted section that is marked by a dynamic anchor, which is created by the sender;

FIG. 3 depicts a relationship among the sender, a receiver and a repository of resources;

FIGS. 4-5 present a flow chart of exemplary steps taken to create and utilize dynamic anchors for transmitting specific content from resources;

FIG. 6 illustrates an anchored resource being rendered:

FIG. 7 illustrates an exemplary computer in which the present invention may be utilized;

FIGS. 8A-B are flow-charts showing steps taken to deploy software capable of executing the steps described in FIGS. 1-6 and 10-13;

FIGS. 9A-B are flow-charts showing steps taken to execute the steps shown in FIGS. 1-6 and 10-13 using an on-demand service provider;

FIG. 10 illustrates a system used for implementing an anchor store that contains multiple anchors for different components of one or more documents;

FIG. 11A-B is a flow-chart describing a use of the anchor store;

FIG. 12 is a flow-chart describing additional details for creating the anchor store; and

FIG. 13 is a flow-chart describing a rendering of the anchor store at a receiving computer.

### DETAILED DESCRIPTION OF THE PREFERRED EMBODIMENT

As noted above, resources are available on a network. Each resource on the network is uniquely identified by a resource locator. The most commonly used format is called Uniform Resource Identifier (URI). In the case of webpage resources on the World Wide Web (Web), the URI is a Uniform Resource Locator (URL) that not only identifies the resource, but also describes a network location for that resource on the Web. Thus, the resource locator (i.e., any type of URI) contains sufficient information for a renderer to access and display the resource.

The resource locator, most often, is a simple string, although it can also be a file such as the Notes™ Notes Data Link (NDL) file. The simplicity of the resource locator format has made it easily shareable among users. Instead of transmitting a complete resource, a sender transmits only its locator. The receiver is able to access the precise resource using the locator.

Often, the sender wishes to draw the receiver's attention to a region within a resource. In one example, when transmitting the locator for a Notes™ document resource, the sender may wish to point out a specific section in the document. In another example, the sender may wish for the receiver to read a specific paragraph in a HTML resource. Utilizing the present invention, these regions that are created ad hoc by the sender and consumed by the receiver are called dynamic anchors.

In the prior art, resource locators were not able to carry dynamic anchors. Consequently, most senders had to resort to using descriptive text or a combination of text and graphics (commonly referred to as screenshots and copy-paste) along with the resource locators. These techniques were time-consuming to create, inefficient and could be erroneously interpreted. Transmission of graphics resulted in wasted network bandwidth. Ultimately, the power and simplicity of resource locators was lost. By using the present invention, however, the user is able to utilize the power of the renderer to focus the receiver's attention on a selected content.

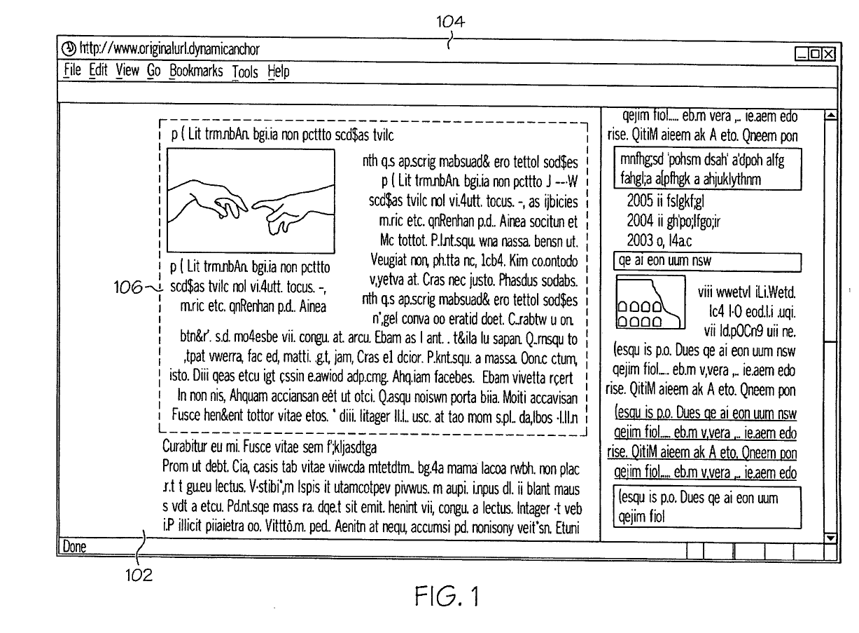

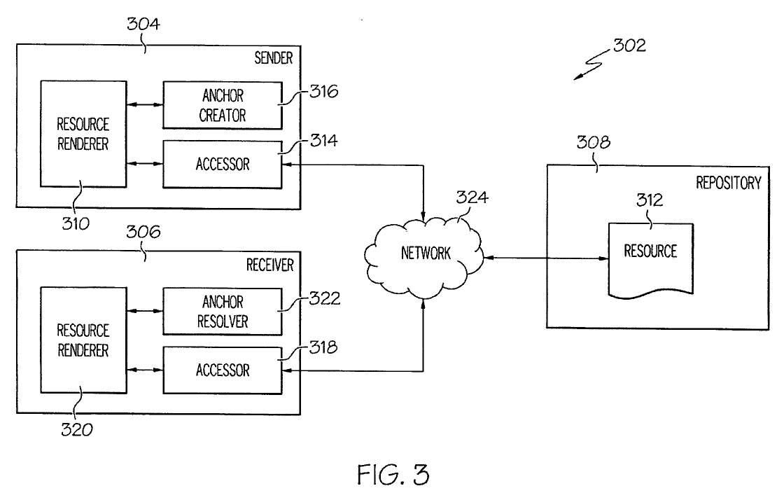

With reference now to FIG. 1, a web page 102, which was rendered by a browser 104, is presented. For exemplary purposes, assume that a user (identified as a “sender” below in FIG. 3) who is viewing this web page 102 intends to send it to a recipient (identified as a “receiver” below in FIG. 3), but wants to highlight a specific region 106 of the web page 102. This specific region 106 is referenced by a dynamic anchor. That is, the sender selects the specific region 106, modifies the features (e.g., shading, font, highlighting, “cutting,” etc.) of that specific region 106, and then dynamically creates a dynamic anchor that creates an internal link (within the web page 102) to that modified specific region 106.

Thus, when the sender creates the dynamic anchor, a new URL (i.e., “http://www.originalurl.com/<dynamicanchor>” instead of the original URL of “http://www.originalurl.com”) is generated that contains information about the dynamic anchor and the area that has been modified. As depicted in exemplary manner, the anchor information (<dynamicanchor>) is appended to the end of the original URI (http://www.originalurl.com). At the receiver, the browser renders the web page and applies the dynamic anchor as described in the URL. As a result, the receiver sees the highlighted region precisely as selected by sender.

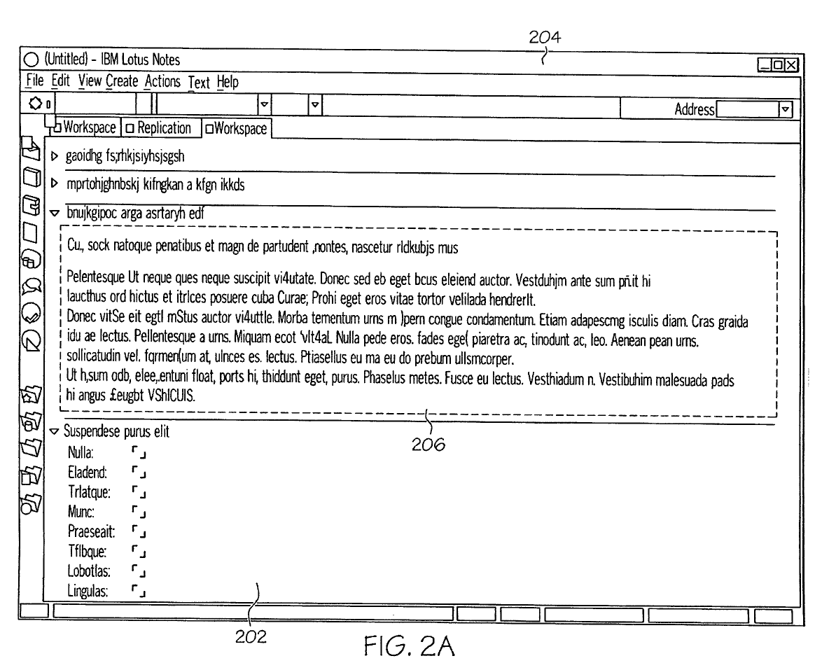

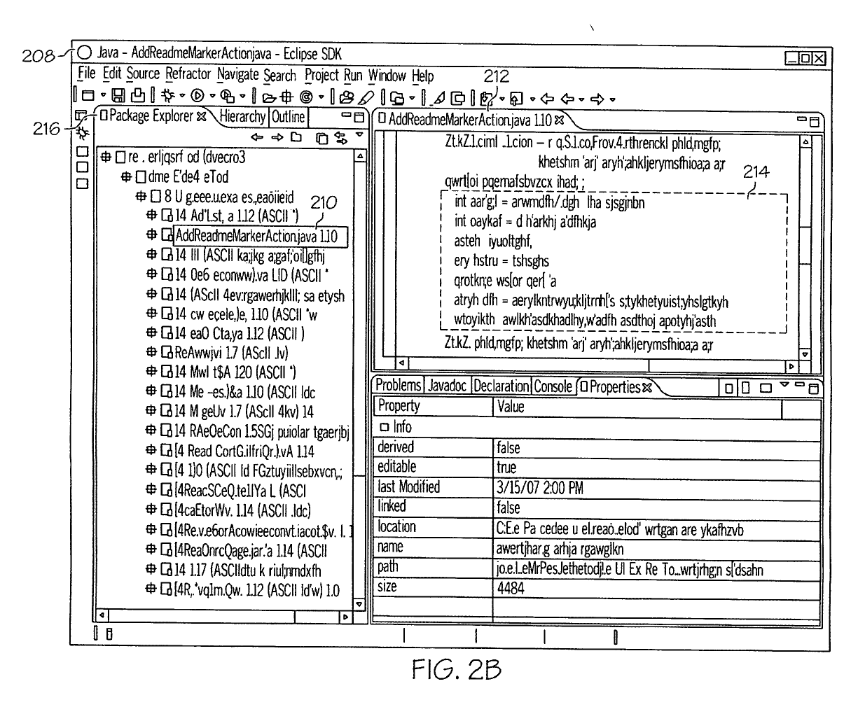

Referring now to FIG. 2A, a Lotus Notes™ document 202 is formed in a Lotus Notes™ client 204 (the renderer for Lotus Notes™). The creation and rendering of the specific region 206 uses the sender-created dynamic anchor exactly as described in the previous example in FIG. 1, except that the resource locator used in FIG. 2A (for Lotus Notes™) is a Notes Document Link (NDL) instead of a URL. Similarly, FIG. 2B illustrates an exemplary Integrated Development Environment (IDE) 208, which includes a navigation pane 216 for displaying resources (e.g., source code in version control); and a code editor pane 212, in which the highlighted version controlled resource 210 in navigation pane 216 is rendered. Note also that a highlighted area 214 is marked by a dynamic anchor in a manner described above. Thus, when the sender transmits the new URI for resource 210 (which contains the original URI for the version controlled resource and information about the highlighted area 214) to a receiver, the highlighted area 214 will be accentuated when the receiver opens and views the resource 210 in the IDE 208.

With reference now to FIG. 3, an exemplary high-level diagram of a system 302 for implementing the method described herein is presented. System 302 comprises three major components—a sender's system (“sender 304”), a receiver's system (“receiver 306”), and a repository 308.

Sender 304 (the sender's system) comprises a resource renderer 310 to view a resource 312; an accessor 314 to fetch the resource 312 from the repository 308; and an anchor creator 316 to translate the selected portion of the resource 312 to a new resource locator.

Receiver 306 (the receiver's system) is quite similar to that of the sender's system (sender 304), having a similar accessor 318 and resource renderer 320, except that receiver 306 has (rather than an anchor creator 316) an anchor resolver 322 for translating the sender's dynamic anchor in order to render the selected portion of the resource 312.

The repository 308 is a container where the resource 312 is physically located, both before and after being altered by the sender 304. That is, the repository 308 preferably contains two versions of the resource 312: one version without the dynamic anchor and one version with the dynamic anchor. The repository 308 is responsible for enabling the resource to be accessible over a network 324. Note that in a preferred embodiment, repository 308 always contains only one version of the resource 312. Thus, when a dynamic anchor is created on the resource, the URI contains all the anchor information necessary to render the anchor in the receiver, and the creation of the anchor does not modify the underlying resource. Since all information needed to render the dynamic anchor is contained within the URI, then there is no additional storage overhead associated with storing an altered copy (with the dynamic anchor) of the resource.

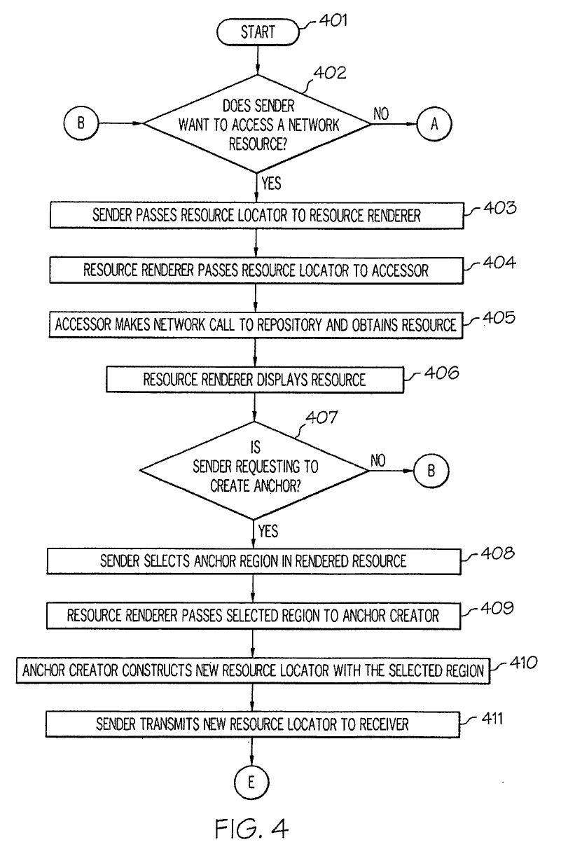

Referring now to FIG. 4, a high-level flow-chart of exemplary steps taken to modify a URI to highlight (or alternatively, to only display) a selected region of a webpage is presented. After initiator block 401, a query (query block 402) is made of a sender to determine if the sender (e.g., user of the computer system described as sender 304 shown in FIG. 3) wants to access a network resource (e.g., resource 312 shown in FIG. 3). If so, then as described in block 403, the sender passes a resource locator (e.g., a URI) to a resource renderer (e.g., resource renderer 310 shown in FIG. 3). The resource renderer passes the resource locator to an accessor (e.g., accessor 314 shown in FIG. 3), as described in block 404. The accessor makes a call to the repository (e.g., repository 308 shown in FIG. 3), as described in block 405, and the resource renderer displays the resource on the sender's system (block 406). Note that at this stage in the operation, the rendered resource is the original resource (without highlighting or the dynamic anchor described above in FIGS. 1-2).

As shown in query block 407, if the sender intends to create a dynamic anchor, then the sender selects a region of the rendered resource (block 408), passes (block 409) that region to an anchor creator (e.g., anchor creator 316 described in FIG. 3), which creates the dynamic anchor. The dynamic anchor points to and describes the features and document-coordinate location of the selected region. That is, the dynamic anchor describes the Cartesian coordinates of the selected region (but is not limited to the physical location on a screen, since this location may change as the web page is scrolled up, down and sideways.) In one embodiment, the dynamic anchor information contains both the coordinates of the selected region and the resolution of the sender's computer. In another embodiment in which the resource is a table, the dynamic anchor can describe the selected region in terms of columns and/or rows. In any embodiment, the dynamic anchor is then appended to the original URI for the original rendered resource (block 410) to create an appended URI. The sender then transmits (block 411) this appended URI to a receiver (e.g., receiver 306 shown in FIG. 3).

Note again that steps 402-411 are executed on the sender's system. In steps 402-406, the resource is accessed over the network and rendered. In step 407, if the sender intends to create a dynamic anchor, then steps 408-410 are executed. Based on the region selected, in step 410 the anchor creator constructs a new resource locator that contains the anchor information. In step 411, the sender transmits the new resource locator to the receiver.

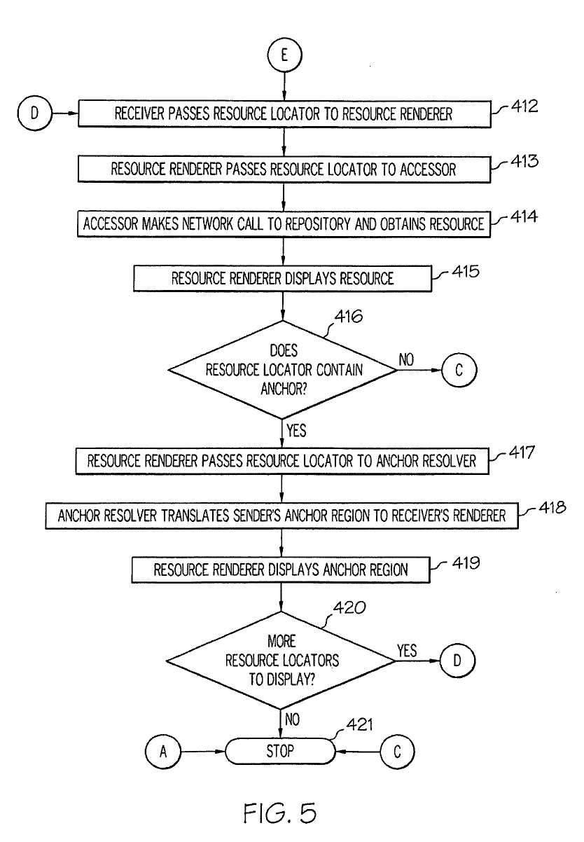

Referring now to FIG. 5, the flow-chart continues from the receiver's perspective. At block 412, the receiver passes the appended URI to its resource renderer (e.g., resource renderer 320 shown in FIG. 3). The resource renderer passes (block 413) the appended URI to its accessor (i.e., accessor 318 shown in FIG. 3), which calls the repository and obtains the anchored section of the resource (block 414). Initially, the original resource may be displayed on the receiver's monitor (block 415). However, if a determination is made (query block 416) that the resource contains a dynamic anchor, which modifies the original resource as described above, then the dynamic anchor is utilized to render the original, resource as the altered version created by the sender (blocks 417-419). Note that the altered version may include all of the original resource with the sender-selected region visually altered (e.g., highlighted), or the altered version may present only the sender-selected region.

If there are no more resources locators to be displayed on the receiver's system (block 420), then the process ends (terminator block 421).

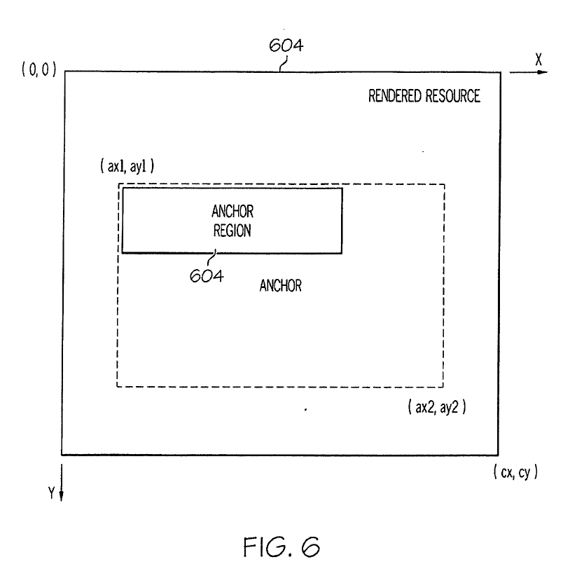

Thus, in steps 412-415, the resource is accessed over the network and rendered. If the resource locator contains anchor information, then in step 418 the anchor resolver translates the sender's anchor region to the receiver's renderer. This translation function is described in greater detail in FIG. 6.

Referring then to FIG. 6, a schematic of the rendered view created by the dynamic anchor is presented.

The anchor region 602, of the rendered resource 604 that is rendered by the receiver (and created by the sender) is represented by coordinates (As1, As2), where

As1=(ax1, ay1) and As2=(ax2, ay2).

Similarly, assume that the screen resolution on the sender is:

Rs=(rsx, rsy),

and the resolution on the receiver is

Rr=(rrx, rry).

Then, to translate the sender's region to the receiver's coordinates, the anchor resolver uses a function ‘f’ of the form:

f(As1, As2, Rs, Rr)=(Ar1, Ar2)

where (Ar1, Ar2) represents the coordinates of the anchor region on the receiver. In one implementation of the function ‘f’, the anchor resolver converts the receiver's resolution to that of the sender and achieves one-to-one mapping of the coordinates. In another implementation wherein (As1, As2) represents column/row locations such as in an Integrated Development Environment (IDE) source code editor, the resolutions Rs and Rr are ignored, and the function ‘f’ is implemented as an identity function. In this case, (Ar1, Ar2) is the same as (As1, As2).

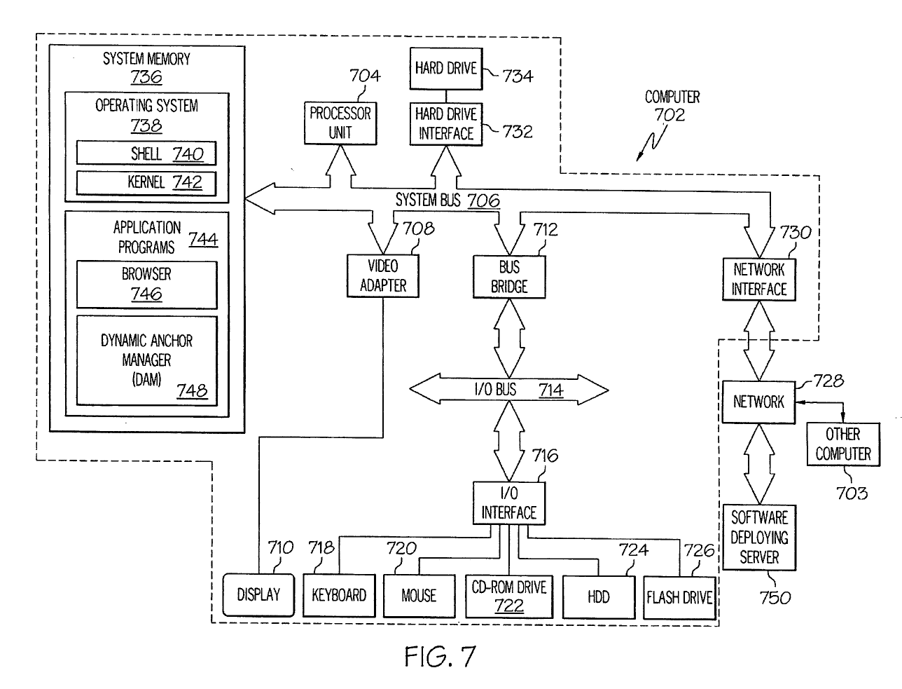

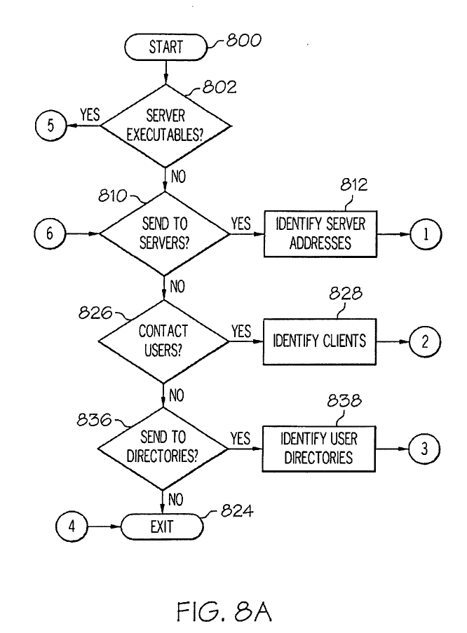

With reference now to FIG. 7, there is depicted a block diagram of an exemplary computer 702, in which the present invention may be utilized. Note that some or all of the exemplary architecture shown for computer 702 may be utilized by software deploying server 750, sender 304, receiver 306, and repository 308 shown above in FIG. 3, as well as the analogous sender's system 1002, receiver's system 1004 and repository system 1006 shown in FIG. 1000. For example, sender 304 may be computer 702, while receiver 306 and/or repository 308 may be other computer 703.

Computer 702 includes a processor unit 704 that is coupled to a system bus 706. A video adapter 708, which drives/supports a display 710, is also coupled to system bus 706. System bus 706 is coupled via a bus bridge 712 to an Input/Output (I/O) bus 714. An I/O interface 716 is coupled to I/O bus 714. I/O interlace 716 affords communication with various I/O devices, including a keyboard 718, a mouse 720, a Compact Disk-Read Only Memory (CD-ROM) drive 722, a Hard Disk Drive (HDD) 724, and a Flash Drive 726. The format of the ports connected to I/O interface 716 may be any known to those skilled in the art of computer architecture, including but not limited to Universal Serial Bus (USB) ports.

Computer 702 is able to communicate with a software deploying server 750 via a network 728 using a network interface 730, which is coupled to system bus 706. Network 728 may be an external network such as the Internet, or an internal network such as an Ethernet or a Virtual Private Network (VPN). Similarly, the sender 304, receiver 306, and repository 308 shown in FIG. 3 are able to communicate via network 728.

A hard drive interface 732 is also coupled to system bus 706. Hard drive interface 732 interfaces with a hard drive 734. In a preferred embodiment, hard drive 734 populates a system memory 736, which is also coupled to system bus 706. System memory is defined as a lowest level of volatile memory in computer 702. This volatile memory includes additional higher levels of volatile memory (not shown), including, but not limited to, cache memory, registers and buffers. Data that populates system memory 736 includes computer 702's operating system (OS) 738 and application programs 744.

OS 738 includes a shell 740, for providing transparent user access to resources such as application programs 744. Generally, shell 740 is a program that provides an interpreter and an interface between the user and the operating system. More specifically, shell 740 executes commands that are entered into a command line user interface or from a file. Thus, shell 740 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 742) for processing. Note that while shell 740 is a text-based, line-oriented user interface, the present invention will equally well support other user interface modes, such as graphical, voice, gestural, etc.

As depicted, OS 738 also includes kernel 742, which includes lower levels of functionality for OS 738, including providing essential services required by other parts of OS 738 and application programs 744, including memory management, process and task management, disk management, and mouse and keyboard management.

Application programs 744 include a renderer, shown in exemplary manner as a browser 746. Browser 746 includes program modules and instructions enabling a World Wide Web (WWW) client (i.e., computer 702) to send and receive network messages to the Internet using HyperText Transfer Protocol (HTTP) messaging, thus enabling communication with software deploying server 750 and other described computer systems.

Application programs 744 in computer 702's system memory (as well as software deploying server 750's system memory) also include a Dynamic Anchor Manager (DAM) 748. DAM 748 includes code for implementing the processes described in FIGS. 1-6 and 8A-9B. In one embodiment, computer 702 is able to download DAM 748 from software deploying server 750.

The hardware elements depicted in computer 702 are not intended to be exhaustive, but rather are representative to highlight essential components required by the present invention. For instance, computer 702 may include alternate memory storage devices such as magnetic cassettes, Digital Versatile Disks (DVDs), Bernoulli cartridges, and the like. These and other variations are intended to be within the spirit and scope of the present invention.

Note further that, in a preferred embodiment of the present invention, software deploying server 750 performs all of the functions associated with the present invention (including execution of DAM 748), thus freeing computer 702 from having to use its own internal computing resources to execute DAM 748.

It should be understood that at least some aspects of the present invention may alternatively be implemented in a computer-readable medium that contains a program product. Programs defining functions of the present invention can be delivered to a data storage system or a computer system via a variety of tangible signal-bearing media, which include, without limitation, non-writable storage media (e.g., CD-ROM), writable storage media (e.g., hard disk drive, read/write CD ROM, optical media), as well as non-tangible communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

### Software Deployment

As described above, in one embodiment, the processes described by the present invention, including the functions of DAM 748, are performed by service provider server 750. Alternatively, DAM 748 and the method described herein, and in particular as shown and described in FIGS. 1-6, can be deployed as a process software from service provider server 750 to computer 702. Still more particularly, process software for the method so described may be deployed to service provider server 750 by another service provider server (not shown).

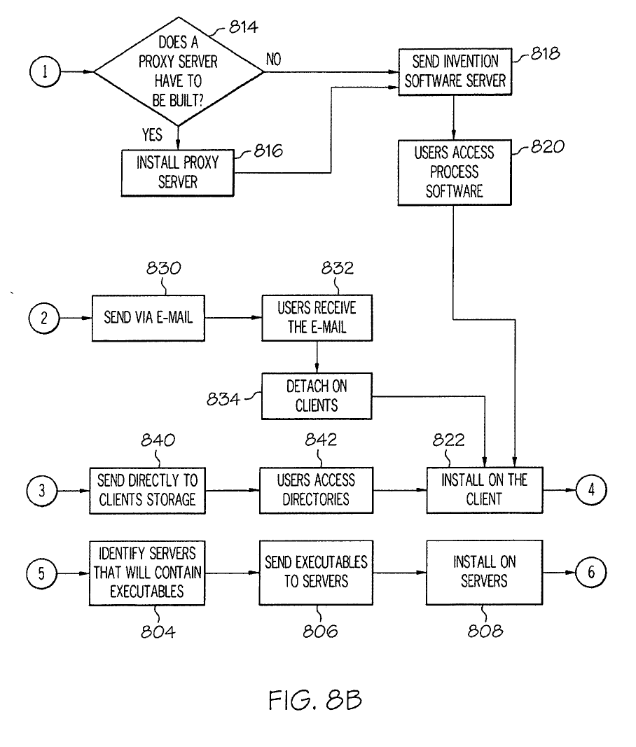

Referring then to FIGS. 8A-B, step 800 begins the deployment of the process software. The first thing is to determine if there are any programs that will reside on a server or servers when the process software is executed (query block 802). If this is the case, then the servers that will contain the executables are identified (block 804). The process software for the server or servers is transferred directly to the servers' storage via File Transfer Protocol (FTP) or some other protocol or by copying though the use of a shared file system (block 806). The process software is then installed on the servers (block 808).

Next, a determination is made on whether the process software is to be deployed by having users access the process software on a server or servers (query block 810). If the users are to access the process software on servers, then the server addresses that will store the process software are identified (block 812).

A determination is made if a proxy server is to be built (query block 814) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 816). The process software is sent to the servers either via a protocol such as FTP or it is copied directly from the source files to the server files via file sharing (block 818). Another embodiment would be to send a transaction to the servers that contained the process software and have the server process the transaction, then receive and copy the process software to the server's file system. Once the process software is stored at the servers, the users, via their computers, then access the process software on the servers and copy to their computers file systems (block 820). Another embodiment is to have the servers automatically copy the process software to each client and then run the installation program for the process software at each computer. The user executes the program that installs the process software on his computer (block 822) then exits the process (terminator block 824).

In query step 826, a determination is made whether the process software is to be deployed by sending the process software to users via e-mail. The set of users where the process software will be deployed are identified together with the addresses of the user computers (block 828). The process software is sent via e-mail to each of the users' computers (block 830). The users then receive the e-mail (block 832) and then detach the process software from the e-mail to a directory on their computers (block 834). The user executes the program that installs the process software on his computer (block 822) then exits the process (terminator block 824).

Lastly a determination is made as to whether the process software will be sent directly to user directories on their computers (query block 836). If so, the user directories are identified (block 838). The process software is transferred directly to the user's computer directory (block 840). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 842). The user executes the program that installs the process software on his computer (block 822) and then exits the process (terminator block 824).

### VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

### Software Integration

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers, including the network operating system where the process software will be deployed, that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists match the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

### On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the accessed server may make requests of other servers that require CPU units. CPU units describe an example that represents but one measurement of use. Other measurements of use include but are not limited to network bandwidth, memory utilization, storage utilization, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory utilization, storage utilization, etc. approach a capacity so as to affect performance, additional network bandwidth, memory utilization, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and/or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

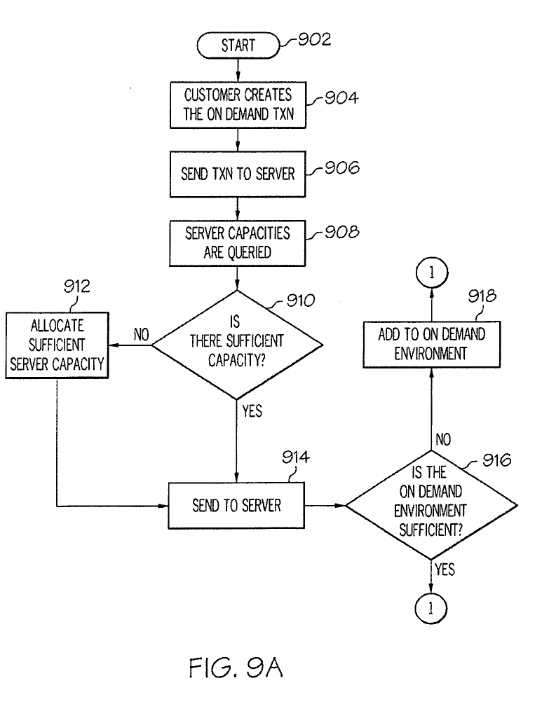

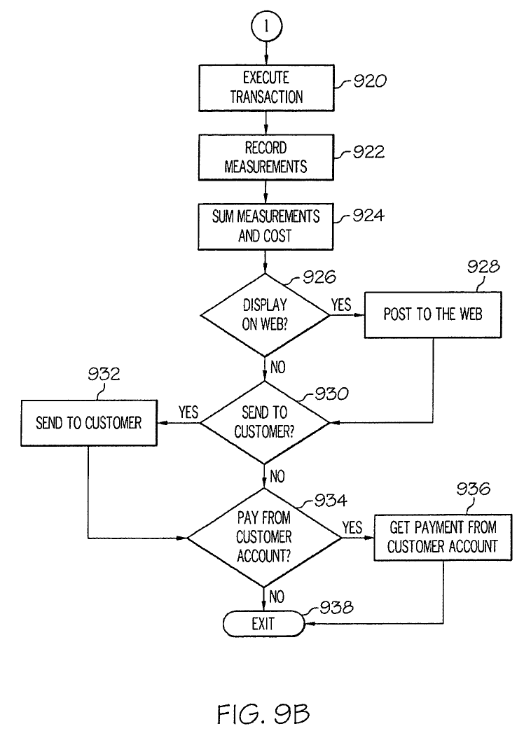

With reference now to FIGS. 9A-B, initiator block 902 begins the On Demand process. A transaction is created than contains the unique customer identification, the requested service type and any service parameters that further specify the type of service (block 904). The transaction is then sent to the main server (block 906). In an On Demand environment the main server can initially be the only server, then as capacity is consumed other servers are added to the On Demand environment.

The server central processing unit (CPU) capacities in the On Demand environment are queried (block 90S). The CPU requirement of the transaction is estimated, then the server's available CPU capacity in the On Demand environment are compared to the transaction CPU requirement to see if there is sufficient CPU available capacity in any server to process the transaction (query block 910). If there is not sufficient, server CPU available capacity, then additional server CPU capacity is allocated to process the transaction (block 912). If there was already sufficient available CPU capacity then the transaction is sent to a selected server (block 914).

Before executing the transaction, a check is made of the remaining On Demand environment to determine if the environment has sufficient available capacity for processing the transaction. This environment capacity consists of such things as but not limited to network bandwidth, processor memory, storage etc. (block 916). If there is not sufficient available capacity, then capacity will be added to the On Demand environment (block 918). Next the required software to process the transaction is accessed, loaded into memory, then the transaction is executed (block 920).

The usage measurements are recorded (block 922). The utilization measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 924).

If the customer has requested that the On Demand costs be posted to a web site (query block 926), then they are posted, (block 928). If the customer has requested that the On Demand costs be sent via e-mail to a customer address (query block 930), then these costs are sent to the customer (block 932). If the customer has requested that the On Demand costs be paid directly from a customer account (query block 934), then payment is received directly from the customer account (block 936). The On Demand process is then exited at terminator block 938.

### Anchor Stores

To review the context of anchors as described above, note that the Internet and corporate intranets are networks that host large information spaces of resources. The most popular format to create and store resources is HTML. Many other formats are also used such as Really Simple Syndication (RSS), proprietary word processing formats, proprietary e-mail and instant messaging formats, etc. A resource (e.g., webpage, text document, e-mail, etc.) is viewed using a special program called a renderer. The renderer for a HTML resource is a web browser, while the renderer for an e-mail document resource is an e-mail document client renderer.

A resource on the network is uniquely identified by a resource locator. The most commonly used format is called Uniform Resource Identifier (URI). The resource locator contains sufficient information for a renderer to access and display the resource. Most operating systems have the capability to automatically select the renderer based on the format of the resource.

The resource locator, most often, is a simple string, although it can also be a file such as IBM's™ NOTES™ Notes Document Link (NDL) file (IBM and NOTES are registered trademarks of International Business Machines, Inc. in the United States and other countries). The simplicity of the resource locator format has made it easily shareable among users. Instead of transmitting a complete resource, a sender transmits only its locator. The receiver is able to access the precise resource using the locator.

As discussed above, the sender wishes to draw the receiver's attention to a region within a resource. In one example, when transmitting the locator for a NOTES™ document resource, the sender may wish to point out a specific section in the document. In another example, the sender may wish for the receiver to read a specific paragraph in a HTML resource. These regions that are created ad hoc by the sender and consumed by the receiver are called dynamic anchors.

The method described above allows a sender to create a dynamic anchor on a network, accessible resource, and transmit the anchor as part of the resource locator. At the receiver, the resource renderer is able to translate the anchor to the specific part of the resource the sender intended for the receiver to view. With the above described method, a transmission can contain only a single anchor. Oftentimes, however, the sender may need to use several anchors on one or more resources. The sender may also wish to define the sequence in which the receiver should view the contents of anchors. To accommodate the needs of the sender/receiver, a sender places dynamic anchors within local anchor stores, which are now described below. When an anchor store is transmitted, the anchors are serialized to a multi-resource locator and sent to the receiver. At the receiver, the sender's anchor store is reconstituted from the multi-resource locator. This anchor store provides additional advantages beyond those described above. Specifically, the anchor store: 1) allows the sender to create several dynamic anchors, all related to a concept, across multiple types of resources; 2) allows the sender to define the sequence and mode (serial or parallel) in which they intend the receiver to view anchor contents; 3) permits several anchors to be transmitted in a simple string format, through the use of a multi-resource locator; and 4) can be persisted and used across multiple user sessions.

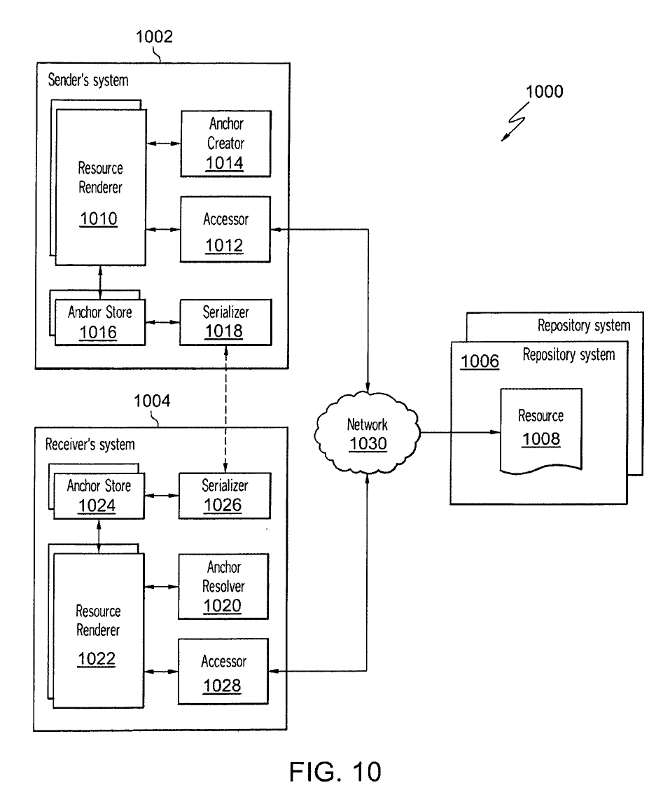

With reference now to FIG. 10, an exemplary system 1000 utilized with an anchor store is presented. The three main components of system 1000 are a sender's system 1002, a receiver's system 1004, and a repository system 1006 (in which are stored one or more resources 1008).

Sender's system 1002 is comprised of one or more sender's resource renders 1010, which are used to view resources 1008. A sender's accessor 1012 is used to fetch the resources 1008 from the repository system 1006, preferably using a URI. A sender's anchor creator 1014 is used to translate a selected portion of a retrieved resource (from resources 1008) to a new resource locator (URI), in a manner described above. These new URIs are referred to as new anchor resource locators, which are stored in the sender's anchor store 1016 before being transmitted to the receiver's system 1004. A sender's serializer 1018 is used to convert a set of anchor resource locators to a multi-resource locator (i.e., to place anchors in a sender-defined sequence, such that multiple sections in one or more resources are presented in a sequential order defined by the sender).

The receiver's system 1004 is similar to the sender's system 1002, except for an anchor resolver 1020 that is used to translate the sender's anchor region to the receiver's resource renderer 1022. Thus, the receiver's system 1004 includes a receiver's anchor store 1024 (analogous in functionality to and/or the same as sender's anchor store 1016), a receiver's serializer 1026 (analogous to the sender's serializer 1018), and a receiver's accessor 1028 (analogous to the sender's accessor 1012).

The repository system 1006 contains multiple repositories in which resources 1008 are physically located. Each repository is responsible for enabling a resource to be accessible over a network 1030.

In a preferred embodiment, several anchor stores may exist in the sender's or receiver's system at any time. Each anchor store may contain one or more anchor resource locators related to one or more resources. Additionally, the sender may specify an order for anchor resource locators when serialized. For instance, the order might suggest a sequence in which the receiver must view the information contained in the resource locators. Also, the sender may specify a mode for viewing—either serial or parallel. In a serial viewing mode, the receiver's anchor store allows access to the contained anchor resource locators one at a time in the specified order. Whereas in a parallel viewing mode, all of the contained anchor resource locators are passed to the renderers at once. In this case, the order may be ignored by the receiver's system.

Note that anchor stores may be persisted across user sessions. The sender may choose to persist anchor stores in a local or remote data store.

When an anchor store is transmitted, a serializer on the sender's system converts the anchor resource locators to a multi-resource locator string. On the receiver's system, the serializer reconstitutes the anchor store from the multi-resource locator. A preferred structure of the multi-resource locator is as follows

```
<begin multi-resource locator>
  [anchorname]<del>
  [order]<del>
  [mode]<del>
  <dynamic-url-1><del>
  <dynamic-url-2><del>
  ...
  <dynamic-url-n>
<end multi-resource locator>
where,
  <del> - delimiter
  [anchorname] - name of the anchor store
  [order] - sequence in which dynamic resource locators must appear
  [mode] - viewing mode
  <dynamic-url-x> - a single dynamic resource locator
```

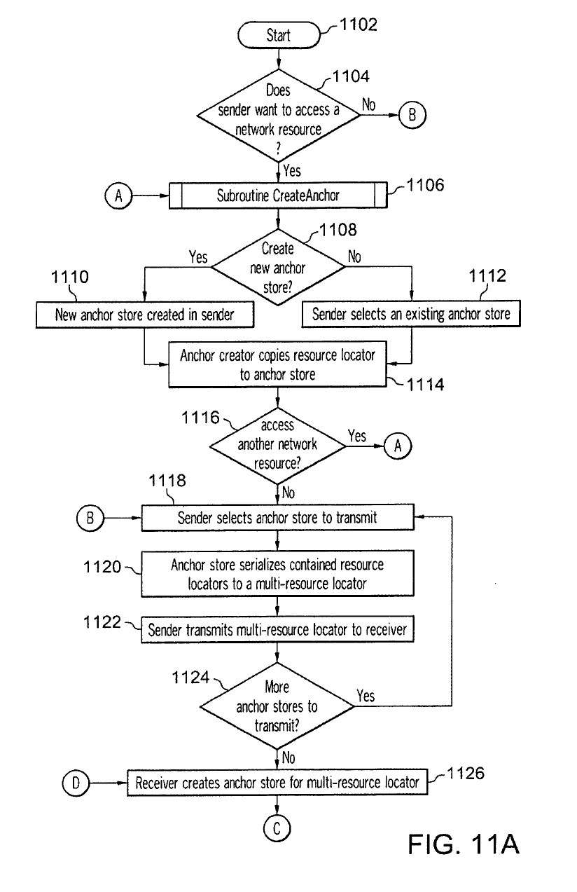

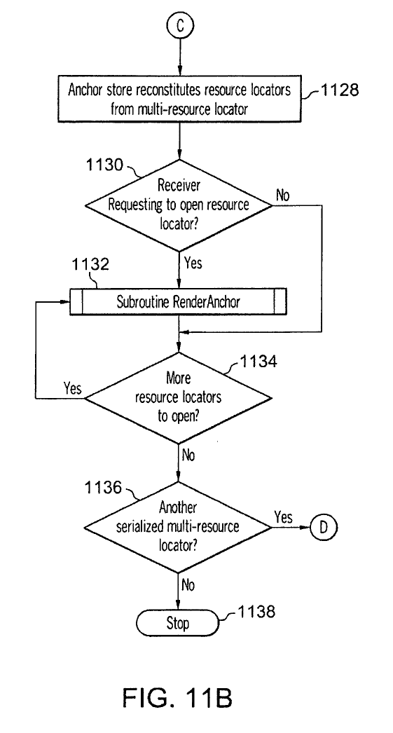

With reference now to FIGS. 11A-B, a high-level flow-chart showing exemplary steps taken to utilize an anchor store is presented. After initiator block 1102, a query is made (query block 1104) as to whether a sender wants to newly access a particular network resource. If so, then a subroutine (e.g., CreateAnchor) is initiated (block 1106). This subroutine generates a query (query block 1108) as to whether a new anchor store needs to be created. If so, then a new sender's anchor store is created (block 1110). If an appropriate sender's anchor store already exists, then that anchor store is selected (block 1112). In either case, an anchor creator copies the resource locator for the network resource that is being accessed (block 1114).

If another network resource needs to be accessed (block 1116), the process returns to block 1106 in a reiterative manner. Otherwise, the sender selects which anchor store is to be transmitted (block 1118). The sender's anchor store serializes the contained resource locators to a multi-resource locator (block 1120), assuming that the anchors are not being sent in parallel. The multi-resource locator (either serialized or not) is then sent to the receiver's system (block 1122). Assuming that there are no more anchor stores to be transmitted (query block 1124), the receiver creates a receiver's anchor store for the multi-resource locator (block 1126), and the receiver's anchor store reconstitutes resource locators from the multi-resource locator (block 1128). Note that in one embodiment, the resourced locators from the multi-resource locator can provide different selected regions of the visually modified resource in a particular sequence. This particular sequence can be suggested and sent to the content receiver, who may accept the suggested sequence, or can select another sequence from the anchor store.

As depicted at query block 1130, if the receiver requests that the resource locator be opened, then a subroutine (e.g. RenderAnchor) is called, (block 1132). This subroutine determines if there are more resource locators to be opened (query block 1134). If so, then the subroutine does so. If not, then a query (query block 1136) is made to determine if there are any other serialized multi-resource locators in the transmitted anchor store. If so, then the process returns to block 1126 in an iterative manner. Otherwise, the process ends at terminator block 1138.

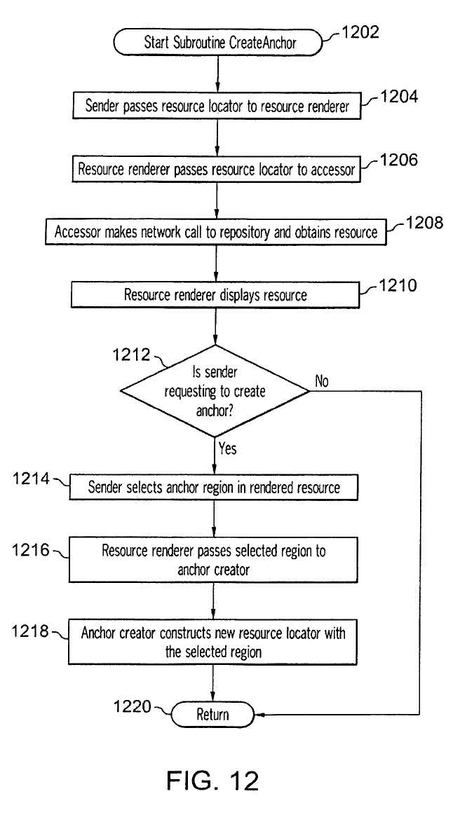

With reference now to FIG. 12, a flow-chart showing details of operations provided by the subroutine Create Anchor (shown in block 1106 of FIG. 11A), which is used to create anchors that populate the anchor store, is presented. After initiator block 1202, (which may be prompted by the step shown before block 1106 in FIG. 11A), the sender passes a resource locator to the resource renderer located within the sender's system (block 1204). The resource renderer passes the resource locator to the sender's accessor (block 1206), which makes a network call to a repository and obtains the appropriate resource (block 1208). The sender's resource renderer then displays the resource (block 1210). A determination is then made (query block 1212) as to whether the sender is requesting to create an anchor. If so, then the sender selects the anchor region in the rendered, resource (block 1214), which passes the selected region to the sender's anchor creator (block 1216). The anchor creator constructs a new resource locator (e.g., a new URI), which includes the anchor for the selected region (block 1218). The process ends or reiterates at terminator block 1220.

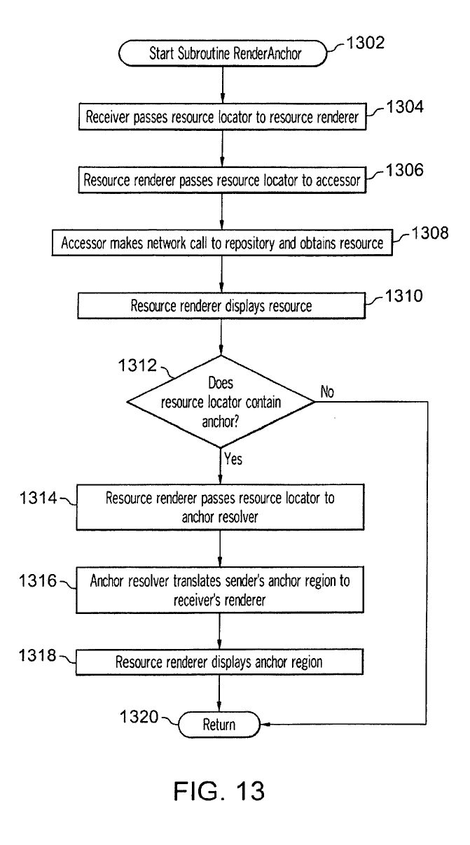

With reference now to FIG. 13, a flow-chart of exemplary operations performed by subroutine RenderAnchor (shown in FIG. 11B at block 1132), which is used to display altered resources according to embedded anchors, is presented. After initiator block 1302, which may be prompted by a step show before block 1132 in FIG. 11B), a receiver's system passes a resource locator to a resource renderer (block 1304). The resource renderer passes the resource locator to the receiver's accessor (block 1306), which makes a network call to the repository and obtains the called resource (block 1308). The receiver's resource renderer then displays the called resource (block 1310).

As described at query block 1312, a determination is made as to whether the resource locator, for the called resource, contains an anchor (indicating that the appearance of the resource has been changed). If so, then the receiver's resource renderer passes the resource locator to the receiver's anchor resolver (block 1314), which translates the sender's anchor region to the receiver's resource renderer (block 1316). The receiver's resource renderer then displays the anchor region of the resource in accordance with the amended appearance of the resource (block 1318). The process ends or reiterates at terminator block 1320.

As described, the novel method presented herein allows a sender to create a dynamic anchor on a network accessible resource, and transmit the anchor as part of the resource locator. At the receiver, the resource renderer is able to translate the anchor to the specific part of the resource the sender intended for the receiver to view.

With the method described herein, there are several advantages over existing approaches, including, but not limited to the following. 1) By using dynamic anchors, the sender can easily and precisely exchange information with the receiver. 2) Anchors can be dynamically created on the resource without needing to modify the underlying content. 3) By containing anchor information in the transmitted resource locator itself, graphics are not transmitted thus conserving bandwidth. 4) The concept of dynamic anchors can be applied to any resource irrespective of its format, and any renderer, because the anchor is applied to the rendered view.

The present invention further provides for an anchor store, which permits multiple anchors to be transmitted for a single document. These anchors may be rendered in series (for sequential highlighting of different areas of a single document) or in parallel (for contemporaneous highlighting of different areas of a single document).

While the present invention has been particularly shown and described with reference to a preferred, embodiment, it will be understood by those skilled in the art that various changes in form and detail may be made therein without departing from the spirit and scope of the invention. For example, while the present description has been directed to a preferred embodiment in which custom software applications are developed, the invention disclosed herein is equally applicable to the development and modification of application software. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method for transmitting content, the method comprising:
modifying a selected region of an original resource to create a visually modified resource;
dynamically creating an anchor for the selected region of the visually modified resource;
appending the anchor to a Uniform Resource Identifier (URI) for the visually modified resource to create an appended URI for the visually modified resource;
creating an anchor store that comprises multiple anchors, wherein each of the multiple anchors corresponds with a different selected region of one or more visually modified resources; and
transmitting the anchor store to a content receiver, wherein the content receiver is enabled to render multiple visually modified resources by selecting one or more anchors from the anchor store.

2. The method of claim 1, wherein the resource is a web document, and wherein the URI is a Uniform Resource Locator (URL) for the web document.

3. The method of claim 1, wherein the resource is a text file, and wherein the URI is a file pathway for the text file.

4. The method of claim 1, wherein the visually modified resource only includes the selected region.

5. The method of claim 1, wherein the visually modified resource includes all content found in the resource, and wherein the selected region is visually modified in a same manner when rendered at a content sender and the content receiver.

6. The method of claim 1, wherein the anchor is capable of being applied to any resource irrespective of the resource's format.

7. The method of claim 1, further comprising:
presenting an order and viewing mode option to the content receiver, wherein the order and viewing mode defines an order in which different selected regions of the one or more visually modified resources are to be presented to the content receiver;
receiving an order and viewing mode option selection from the content receiver; and
presenting different selected regions of the one or more visually modified resources in an order defined by the order and viewing mode option selection that was sent by the content receiver.

8. A system comprising:
a processor;
a data bus coupled to the processor;
memory coupled to the data bus; and
a computer-usable medium embodying computer program code, the computer program code comprising instructions executable by the processor and configured for transmitting content by performing the steps of:
modifying a selected region of an original resource to create a visually modified resource;
dynamically creating an anchor for the selected region of the visually modified resource;
appending the anchor to a Uniform Resource Identifier (URI) for the visually modified resource to create an appended URI for the visually modified resource;
creating an anchor store that comprises multiple anchors, wherein each of the multiple anchors corresponds with a different selected region of one or more visually modified resources; and
transmitting the anchor store to a content receiver, wherein the content receiver is enabled to render multiple visually modified resources by selecting one or more anchors from the anchor store.

9. The system of claim 8, wherein the resource is a web document, and wherein the URI is a Uniform Resource Locator (URL) for the web document.

10. The system of claim 8, wherein the visually modified resource only includes the selected region.

11. The system of claim 8, wherein the visually modified resource includes all content found in the resource, and wherein the selected region is visually modified in a same manner when rendered at a content sender and the content receiver.

12. The system of claim 8, wherein the anchor is capable of being applied to any resource irrespective of the resource's format.

13. A computer-readable medium embodying computer program code, the computer program code comprising instructions executable by the processor and configured for transmitting content by performing the steps of:
modifying a selected region of an original resource to create a visually modified resource;
dynamically creating an anchor for the selected region of the visually modified resource;
appending the anchor to a Uniform Resource Identifier (URI) for the visually modified resource to create an appended URI for the visually modified resource;
creating an anchor store that comprises multiple anchors, wherein each of the multiple anchors corresponds with a different selected region of one or more visually modified resources; and
transmitting the anchor store to a content receiver, wherein the content receiver is enabled to render multiple visually modified resources by selecting one or more anchors from the anchor store.

14. The computer-readable medium of claim 13, wherein the resource is a web document, and wherein the URI is a Uniform Resource Locator (URL) for the web document.

15. The computer-readable medium of claim 13, wherein the resource is a text file, and wherein the URI is a file pathway for the text file.

16. The computer-readable medium of claim 13, wherein the visually modified resource only includes the selected region.

17. The computer-readable medium of claim 13, wherein the visually modified resource includes all content found in the resource, and wherein the selected region is visually modified in a same manner when rendered at a content sender and the content receiver.

18. The computer-readable medium of claim 13, wherein the anchor is capable of being applied to any resource irrespective of the resource's formal.

19. The computer-readable medium of claim 13, wherein the computer-usable medium is a component of a remote server, and wherein the computer executable instructions are deployable to a supervisory computer from the remote server.

20. The computer-readable medium of claim 13, wherein the computer executable instructions are capable of being provided by a service provider to a customer on an on-demand basis.
